(19) United States
(12) Patent Application Publication
(10) Pub. No.: US 2012/0218472 A1
(43) Pub. Date: Aug. 30, 2012

(54) DISPLAY DEVICE

(75) Inventors: Masako Wakisaka, Osaka City (JP); Hideaki Watanabe, Osakasayama City (JP)

(73) Assignee: SANYO ELECTRIC CO., LTD., Osaka (JP)

(21) Appl. No.: 13/371,746

(22) Filed: Feb. 13, 2012

(30) Foreign Application Priority Data
Feb. 25, 2011 (JP) 2011-039143
Aug. 30, 2011 (JP) 2011-187144

(51) Int. Cl. H04N 5/445

(52) U.S. Cl. 348/564; 348/E05.105

(57) ABSTRACT

A display device includes: a switching portion that switches a content signal to be received according to a predetermined switching operation such that display content is switched; a menu screen display portion that displays, on a display, a menu screen representing a list of operation items; and a display control portion that controls a display form of the display, in which, when the image and the menu screen are displayed on the display side by side, the display control portion reduces the image, and turns the display form into a first display form in which the reduced image is displayed at a predetermined position on a small screen, and, when the switching operation is performed with the display form being the first display form, the display control portion switches the display content while the first display form is being maintained as the display form.

This nonprovisional application claims priority under 35 U.S.C. §119(a) on Patent Application No. 2011-039143 filed in Japan on Feb. 25, 2011 and Patent Application No. 2011-187144 filed in Japan on Aug. 30, 2011, the entire contents of which are hereby incorporated by reference.

### BACKGROUND OF THE INVENTION

1. Field of the Invention

The present invention relates to a display device that displays images of television broadcast or the like on a display.

2. Description of Related Art

Conventionally, display devices that display images of television broadcast programs or the like have been widely used. Among the display devices, there is a display device that displays a menu screen representing a list of various operation items. For example, with a display device that displays a menu screen on image quality adjustment, a user performs an operation to select, when an image quality adjustment on a certain item is performed, a desired image quality adjustment item through the menu screen, and thereby can perform the intended image quality adjustment.

Among display devices that display a menu screen, there is a display device in which, while the menu screen is being displayed, the image of a television program or the like in a channel being currently received is additionally displayed. In this type of display device, while the menu screen is being displayed, for example, the image of the television program or the like is reduced and displayed on a small screen. In this type of display form, the menus screen and the image of the television program or the like can be prevented from interfering with each other, and can be displayed side by side. In a display device that can be connected to the Internet, while the content of a connection site on the Internet is being displayed, the image of a television program or the like is likely to be displayed on a small screen.

With the display device in which, while the menu screen or the like is being displayed, the image of the television program or the like is displayed on the small screen, a user can reference the image when performing an operation or the like on the menu screen. However, in the state where, while the menu screen or the like is being displayed, the image of the television program or the like is displayed on the small screen, the display of the image is regarded as being additional.

Hence, even if, in the state where, while the menu screen or the like is being displayed, the image of the television program or the like is displayed on the small screen, an operation of switching a reception channel or the like is performed, such a state is maintained, and the television program or the like being displayed is not switched. For example, even if the switching operation is performed in such a state, the operation is regarded as an operation that is not related to the menu screen or the like, and thus the switching operation becomes invalid, or the state is returned to a state where the image of the television program or the like is displayed normally (the state where the menu screen is not displayed).

However, if, as in a case, for example, where the display device has just been purchased, the menu screen has not been customized by the user, the user may need much time to customize the menu screen or may have difficulty in operating the menu screen. Hence, as a result, it may take more time to display the menu screen. When connection is made to the Internet, the content of a connection site on the Internet may be displayed for a long period of time.

In this case, it can be considered that, while the user is operating the menu screen, another user watches the image of the television program or the like being displayed on the small screen. When a relatively long standby time is needed while the menu screen is being operated, it can be considered that, in the meantime, the user watches the image of the television program or the like being displayed on the small screen. When the content of a connection site on the Internet is displayed for a long period of time, it can be considered that, in the meantime, the user watches the image of the television program or the like being displayed on the small screen.

With consideration given to these cases, it is preferable that the user can switch the television program or the like being displayed on the small screen such that the user can watch the image of the desired television program or the like while the menu screen or the like is being displayed. When the menu screen on image quality adjustment is operated, the user is likely to try to reference the images (for example, images in different broadcast channels) of a plurality of television programs or the like.

### SUMMARY OF THE INVENTION

In view of the foregoing conditions, it is preferable to provide a display device which displays, while a menu screen or the like is being displayed, the image of a television program or the like on a small screen and in which a user can switch the television program or the like being displayed on the small screen.

According to the present invention, there is provided a display device that selectively receives any one of a plurality of content signals and that displays an image of the received content signal on a display, the display device including: a switching portion that switches the content signal to be received according to a predetermined switching operation such that display content displayed on the display is switched; a menu screen display portion that displays, on the display, a menu screen representing a list of operation items; and a display control portion that controls a display form of the display, in which, when the image and the menu screen are displayed on the display side by side, the display control portion reduces the image, and turns the display form into a first display form in which the reduced image is displayed at a predetermined position on a small screen, and, when the switching operation is performed with the display form being the first display form, the display control portion switches the display content while the first display form is being maintained as the display form.

According to the present invention, there is provided a display device that selectively receives any one of a plurality of content signals and that displays an image of the received content signal on a display, the display device including: a switching portion that switches the content signal to be received according to a predetermined switching operation such that display content displayed on the display is switched; a net content display portion that displays, on the display, net content provided through the Internet; and a display control portion that controls a display form of the display, in which, when the image and the net content are displayed on the display side by side, the display control portion reduces the image, and turns the display form into a fourth display form in which the reduced image is displayed at a predetermined position on a small screen, and, when the switching operation is performed with the display form being the fourth display form, the display control portion switches the display content while the fourth display form is being maintained as the display form.

According to the present invention, there is provided a display device including: a display; a reception portion that receives a content signal; an acquisition portion that acquires net content provided through the Internet; and a display portion that displays, on the display side by side, the net content and an image of the content signal displayed on a small screen, in which, when the content signal to be received is switched with the side-by-side display produced, the image displayed on the small screen is switched to an image of a content signal that is received after the switching.

### BRIEF DESCRIPTION OF THE DRAWINGS

An object and a feature of the present invention will be more apparent from the following description of preferred embodiments and reference to accompanying drawings representing the following description.

FIG. 1 is a block diagram of a display device according to a first embodiment of the present invention;

FIG. 2 is a diagram illustrating and showing a display form of a display in a normal mode;

FIG. 3 is a diagram illustrating a first display form;

FIG. 4 is another diagram illustrating the first display form;

FIG. 5 is a diagram illustrating a second display form;

FIG. 6 is a diagram illustrating a third display form;

FIG. 7 is another diagram illustrating the third display form;

FIG. 8 is a block diagram of a display device according to a second embodiment of the present invention;

FIG. 9 is a diagram showing an appearance of a remote control transmitter according to the second embodiment of the present invention;

FIG. 10 is a diagram illustrating a net mode;

FIG. 11 is a diagram illustrating a net portal screen; and

FIG. 12 is a diagram illustrating a ticker mode.

### DETAILED DESCRIPTION OF PREFERRED EMBODIMENTS

Embodiments of the present invention will be described below with reference to accompanying drawings, using the first embodiment and the second embodiment as examples.

### 1. The First Embodiment

### [Configuration and the Like of a Display Device]

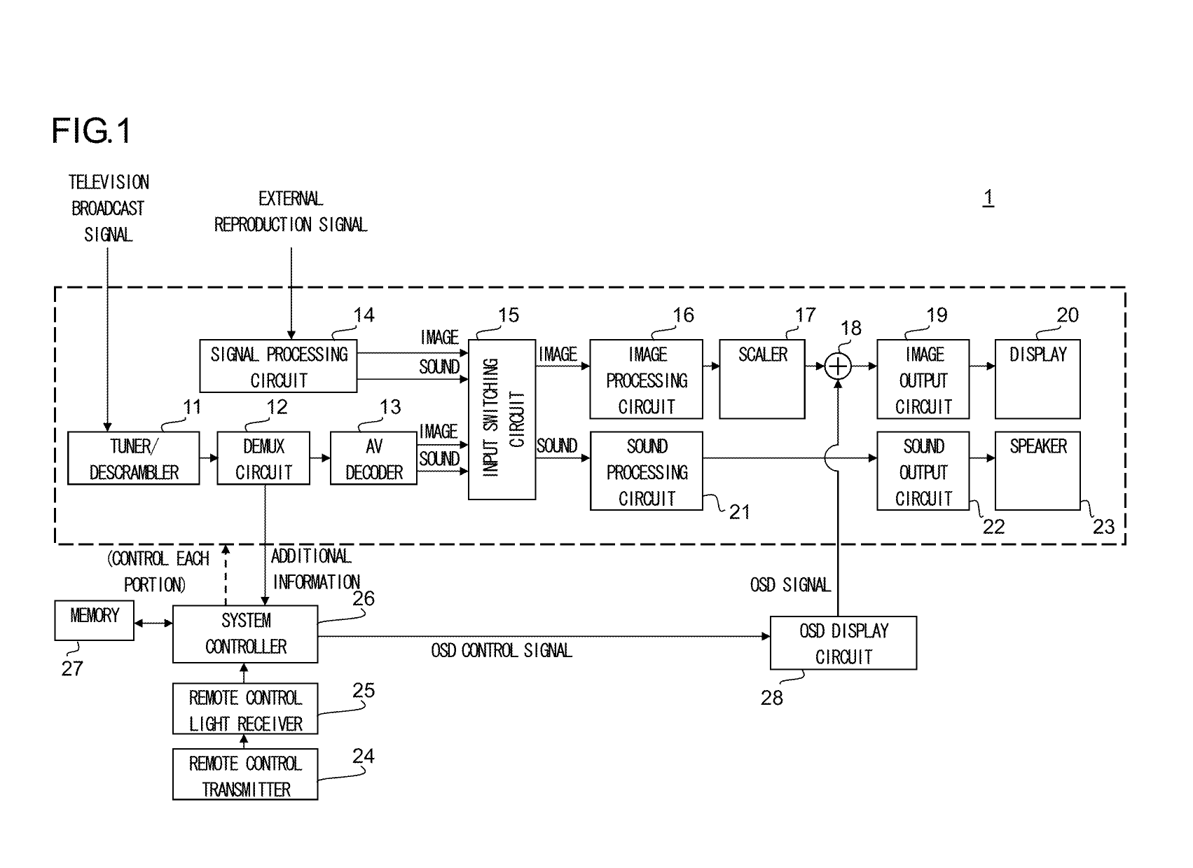

The first embodiment will first be described. FIG. 1 is a block diagram of a television receiver that is a display device according to the present embodiment. As shown in the figure, the television receiver 1 includes a tuner/descrambler 11, a DEMUX circuit 12, an AV decoder 13, a signal processing circuit 14, an input switching circuit 15, an image processing circuit 16, a scaler 17, a combination circuit 18, an image output circuit 19, a display 20, a sound processing circuit 21, a sound output circuit 22, a speaker 23, a remote control transmitter 24, a remote control light receiver 25, a system controller 26, a memory 27 and an OSD display circuit 28.

An antenna or the like is connected to the television receiver 1, and signals for a plurality of types of television broadcast (for example, CS/BS digital broadcast, digital terrestrial broadcast and a CATV) are transmitted. Television broadcast signals in each channel of various types of television broadcast can be regarded as content signals carrying information on the content (one type of content) of a television program.

An external reproduction device (for example, a DVD player) of content is connected to the television receiver 1; an external reproduction signal output from the external reproduction device is transmitted. The external reproduction signal can be regarded as a content signal carrying information on the reproduced content (one type of content).

The tuner/descrambler 11 performs, on externally transmitted television broadcast signals, processing (channel selection processing) for extracting the signals of a currently set reception channel, predetermined high-frequency processing, scrambling cancellation processing, demodulation processing and the like. The signals obtained by these types of processing are fed as a packet to the DEMUX circuit 12. The “reception channel” can be switched by the system controller 26.

The DEMUX circuit 12 decodes the packet received from the tuner/descrambler 11. Here, the packet is classified by the DEMUX circuit 12 into MPEG data indicating the content of a television program and additional information. Then, the MPEG data is fed to the AV decoder 13, and the additional information is fed to the system controller 26. The additional information refers to, for example, information for introducing a television program that is being broadcasted or will be broadcasted in the future and information from a broadcaster; it is broadcasted at predetermined time intervals together with information on the content of a television program.

The AV decoder 13 decodes the MPEG data received from the DEMUX circuit 12 into a video signal and a sound signal, and feeds the video signal and the sound signal to the input switching circuit 15.

Based on the external reproduction signal received from the outside, the signal processing circuit 14 acquires a video signal and a sound signal indicating the reproduced content (content). The signal processing circuit 14 feeds the video signal and the sound signal acquired to the input switching circuit 15.

The input switching circuit 15 sets one of the television broadcast signal and the external reproduction signal to an input target. Then, the input switching circuit 11 transmits, to a circuit on the side of a subsequent stage, only the signal corresponding to the input target at present among the video signal and the sound signal transmitted from the side of a preceding stage.

In other words, when the television broadcast signal is set to the input target, the input switching circuit 15 transmits the video signal and the sound signal transmitted from the AV decoder 13 to the image processing circuit 16 and the sound processing circuit 21, respectively. On the other hand, when the external reproduction signal is set to the input target, the input switching circuit 15 transmits the video signal and the sound signal transmitted from the signal processing circuit 14 to the image processing circuit 16 and the sound processing circuit 21, respectively. The input target can be switched by the system controller 26.

The image processing circuit 16 performs various types of processing on the video signal received from the input switching circuit 15, and feeds it to the scaler 17. The processing performed by the image processing circuit 16 includes various types of image quality adjustment processing (for example, contrast adjustment, brightness adjustment and sharpness adjustment).

The scaler 17 performs, on the video signal, according to an instruction from the system controller 26, processing (small screen processing) for displaying the image on a small screen, and feeds it to the combination circuit 18. The small screen processing includes processing for reducing the image at a predetermined reduction rate and processing for displaying the reduced image at a predetermined portion (see FIG. 3 and the like).

The combination circuit 18 receives the video signal from the scaler 17 and an OSD signal (a signal indicating an OSD display screen) from the OSD display circuit 28, and produces a display signal indicating content obtained by combining (superimposing) the display content of these signals. The display signal is fed to the image output circuit 19.

The image output circuit 19 feeds the received display signal to the display 20 such that the content of the display signal is displayed on the display 20. As the display 20, various displays such as a CRT (cathode ray tube) and a liquid crystal display can be adopted.

The sound processing circuit 21 performs necessary predetermined processing on the sound signal received from the input switching circuit 15, and feeds it to the sound output circuit 22. The sound output circuit 22 feeds the received sound signal to the speaker 23 such that sound indicated by the sound signal is output.

The remote control transmitter 24 is operation means that is used to remotely operate the television receiver 1. The remote control transmitter 24 is provided with various operation switches (such as a push button switch), generates a remote control signal indicating the content of an operation and transmits it wirelessly to the body of the television receiver 1. The body of the television receiver 1 receives the remote control signal through the remote control light receiver 25, and information on the content of the operation is transmitted to the system controller 26. In addition to the remote control transmitter 24, a plurality of types of operation switches (not shown) attached to the body are provided as the operation means of the television receiver 1.

These operation means are provided, and thus the television receiver 1 can reflect the operation of a user (the intension of the user) on various types of operations. As the types of operation switches provided in the remote control transmitter 24 and the body, an “input switching” key, a “channel +” key, a “channel −” key, a “menu” key, number keys (“0” to “9”), a selection key (used for operating a menu screen and the like) and the like are prepared.

The “input switching” key is an operation switch for switching the input target described previously. The “channel +” key is an operation switch for switching the reception channel described previously in ascending order; the “channel −” key is an operation switch for switching the reception channel in descending order. The “menu” key is an operation switch for alternately switching an operation mode of the television receiver 1 between a normal mode and a menu mode (the details thereof will be described later).

The system controller 26 controls the individual portions of the television receiver 1 such that the television receiver 1 operates normally. The content of the main operations performed by the television receiver 1 will be described later.

The memory 27 stores information on various OSD display screens (screens for producing an OSD display on the display 20) and the like. As the OSD display screens, the menu screen, an image quality adjustment screen of various items, a help screen of various items and the like (the details of which will be described later) are previously prepared as predetermined screens, and information on them is stored in the memory 27.

The OSD display circuit 28 receives an OSD control signal (including information on the OSD display screen) from the system controller 26, generates, based on this signal, the OSD signal indicating the OSD display screen and feeds it to the combination circuit 18. Thus, the OSD display screen is OSD-displayed on the display 20. The system controller 26 reads information on the OSD display screen from the memory, generates the OSD control signal and feeds it to the OSD display circuit 28, and thereby can OSD-display the OSD display screen on the display 20.

[Operation of the Display Device and the Like]

The content of the main operations performed by the television receiver 1 as the display device will now be described. As the basic operation (an operation in the normal mode), the television receiver 1 continuously receives the content signal corresponding to the input target and the reception channel at the present, and performs real-time image display (display of content) and sound output on the received content signal.

When the “input switching” key is operated, the system controller 26 accordingly switches the input target. When the “channel +” key or the “channel −” key is operated, the system controller 26 accordingly switches the reception channel. The channel number of one digit to four digits using the number keys (“0” to “9”) is input, and thus it is possible to directly switch the reception channel to the channel of such a number.

When, as described above, the input target or the reception channel is switched, the content signal to be received is switched, and thereafter the image and the sound of another content signal after the switching are output. In other words, the display content to be displayed on the display 20 is switched.

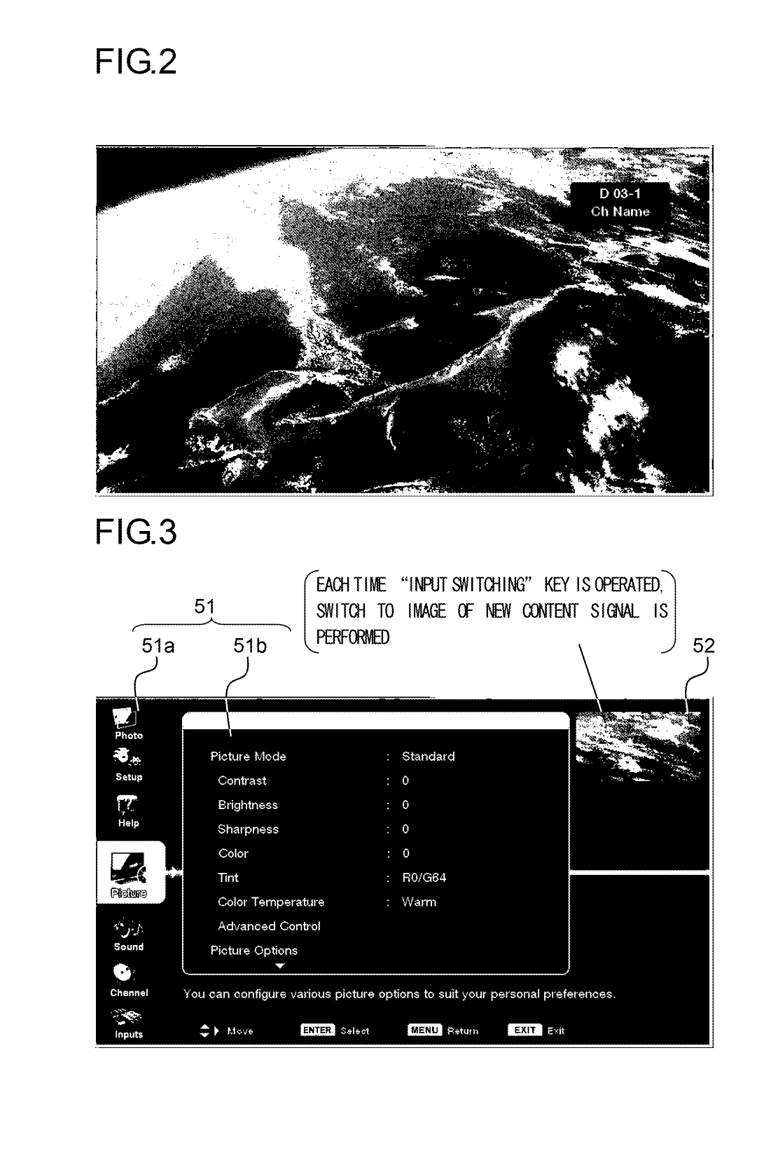

As shown in FIG. 2 (the perimeter of the figure indicates the perimeter of the display region of the display 20; the same is true in FIGS. 3 to 7 described later), the display of an image on the display 20 in the normal mode is realized by the form of overall screen display (a display form in which the frame of the image substantially coincides with the perimeter of the display region of the display 20). As described above, for example, for ease of visibility by the user, the image is displayed such that the size thereof is increased as much as possible.

Based on the additional information and the like obtained by the reception, the system controller 26 can generate the OSD control signal indicating the OSD display screen of the title, the guide and the like of a television program, and can display them on the display 20.

When the “menu” key is operated in the normal mode, the operation mode of the television receiver 1 is transferred to the menu mode. On the other hand, when the “menu” key is operated in the menu mode, the operation mode of the television receiver 1 is transferred to the normal mode. The content of the operation of the television receiver 1 in the menu mode will now be described below with reference to FIGS. 3 to 7.

When the operation mode is transferred to the menu mode, the system controller 26 generates the OSD control signal indicating the menu screen, and feeds it to the OSD display circuit 28. The system controller 26 also controls the scaler 17 so as to perform the small screen processing. Thus, the display signal of content obtained by combining the menu screen and an image of content on the small screen is fed to the display 20.

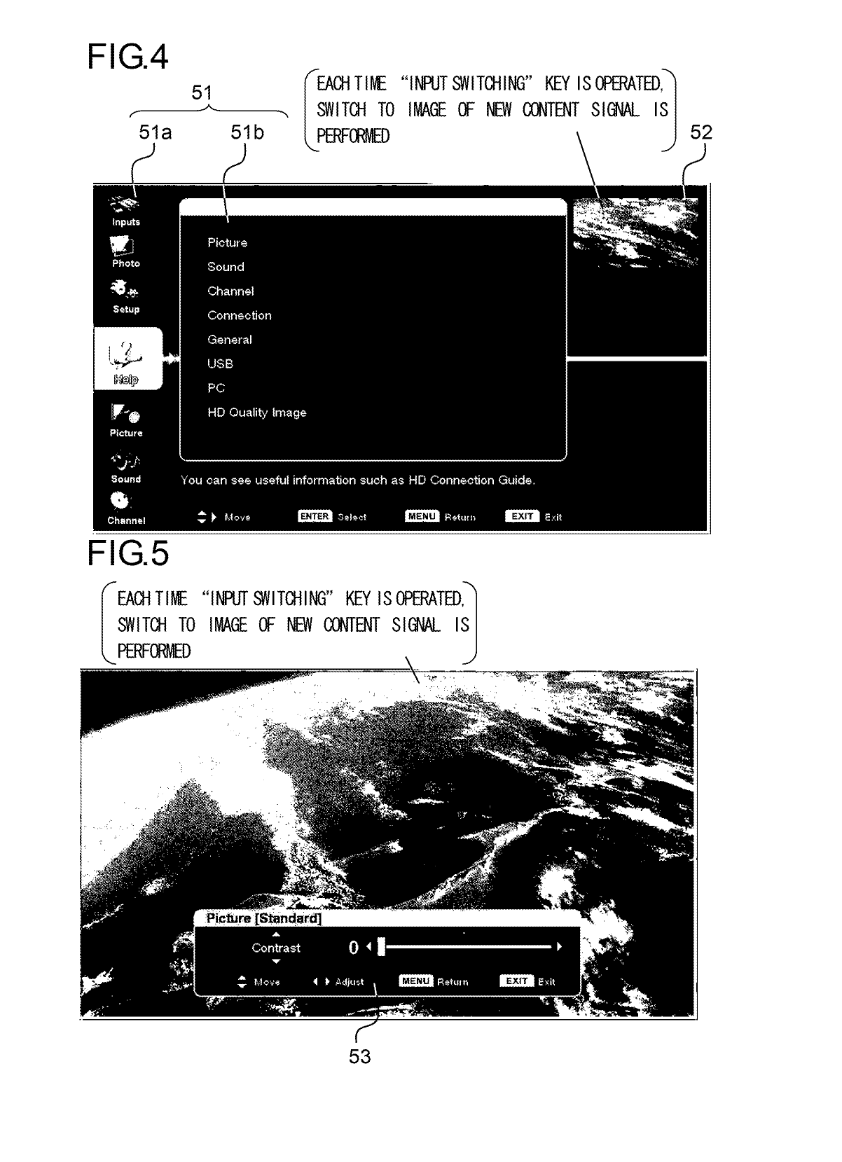

Consequently, as shown in FIGS. 3 and 4, the display form of the display 20 is turned into a form (hereinafter referred to as a “first display form” for convenience) in which the menu screen 51 and an image 52 (display content) on the small screen are displayed side by side.

The menu screen 51 hierarchizes and displays individual items on the television receiver 1, and has an upper hierarchical item display portion 51a on which upper hierarchical items are displayed and a lower hierarchical item display portion 51b on which lower hierarchical items are displayed. While the menu screen 51 is being displayed, the user uses the selection key of the remote control transmitter 24 or the like, and thereby can perform an operation to select a desired upper hierarchical item. Then, when any one of the upper hierarchical items is selected, lower hierarchical items corresponding to such an upper hierarchical item are displayed on the lower hierarchical item display portion 51b, and the user can further perform an operation to select a desired lower hierarchical item.

The image 52 on the small screen is displayed in such a position as not to interfere with (be superimposed on) the menu screen 51. In the display form shown in FIGS. 3 and 4, the image 52 on the small screen is displayed on the upper right side of the lower hierarchical item display portion 51b.

When the display form of the display 20 is the first display form, if an operation of switching the input target or the reception channel is performed, the system controller 26 switches the input target or the reception channel while maintaining the first display form as the present display form. In this way, each time the “input switching” key or the like is operated, the image 52 on the small screen is switched to an image of another content signal (in other words, the display content is switched).

Hence, with the menu screen 51 displayed on the display 20, the user operates the “input switching” key, the “channel +” key, the “channel −” key or the like, thereby switches the image 52 on the small screen, and can watch the image of the desired content signal.

As the upper hierarchical items provided on the menu screen, items that are “Photo”, “Setup”, “Help”, “Picture”, “Sound”, “Channel” and “inputs” are provided. As the lower hierarchical items corresponding to the upper hierarchical item “Picture”, as shown in FIG. 3, items that are “Picture Mode”, “Contrast”, “Brightness”, “Sharpness”, “Color”, “Tint”, “Color Temperature”, “Advanced Control”, “Picture Options” and the like are provided.

These lower hierarchical items represent items (image quality adjustment items) indicating the types of image quality adjustment on the image that is displayed on the display 20. Specifically, on the lower hierarchical item display portion 51b when the upper hierarchical item “Picture” is selected, a list of the image quality adjustment items is displayed. When an operation is performed to select any one of the image quality adjustment items, the system controller 26 allows the user to perform image adjustment on the present item.

More specifically, the system controller 26 controls the scaler 17 such that the small screen processing is prevented from being performed, and feeds the OSD control signal for the image quality adjustment screen corresponding to the present item to the OSD display circuit 28.

Consequently, as shown in FIG. 5, the display form of the display 20 is turned into a form (hereinafter referred to as a “second display form” for convenience) in which an image quality adjustment screen 53 is displayed to overlap an image of content that is displayed to cover the overall screen. FIG. 5 shows, as an example, a display form when an operation is performed to select the image quality adjustment item “Contrast” and thus it is possible for the user to adjust contrast. The image quality adjustment screen 53 functions to show the current image quality level, an operation method and the like to the user and thereby assist an image quality adjustment operation.

While the display form of the display 20 is being the second display form, the system controller 26 is on standby for the image quality adjustment operation that is performed by the user. Then, each time the image quality adjustment operation is operated, the system controller 26 controls the image processing circuit 16 to reflect such image adjustment in real time. This allows the user to operate the image quality adjustment operation while checking the image and easily obtain a desired image quality.

In the second display form, the image of content is displayed to cover the overall screen. Hence, as compared with a case where, as in the first display form, an image is displayed on the small screen, the user more easily grasps the quality of the image, and thereby can perform the image quality adjustment operation more accurately.

When the display form of the display 20 is the second display form, if an operation of switching the input target or the reception channel is performed, the system controller 26 switches the input target or the reception channel while maintaining the second display form as the present display form. The image displayed by this switching is switched to an image of another content signal (in other words, the display content is switched), each time the “input switching” key or the like (including the “channel +” key and the “channel −” key) is operated.

Hence, the user can perform the image quality adjustment operation while operating the “input switching” key, the “channel +” key or the “channel −” key and thereby switching the displayed image as appropriate (while checking the image quality when each image is displayed). When the image quality adjustment is performed as described above, with the image of content displayed to cover the overall screen, it is possible to perform the image quality adjustment operation and the operation of switching the input target or the reception channel, and an attempt to enhance the operability is performed.

On the menu screen 51, as the lower hierarchical items corresponding to the upper hierarchical item “Help”, as shown in FIG. 4, items that are “Picture”, “Sound”, “Channel”, “Connection”, “General”, “USB”, “PC” and “HD Quality Image” are provided.

These lower hierarchical items represent items (help screen items) indicating the types of help screens. In other words, on the lower hierarchical item display portion 51b when the upper hierarchical item “Help” is selected, a list of the help screen items is displayed. When an operation is performed to select any one of these help screen items, the system controller 26 displays the help screen (one type of OSD display screen) of the present item.

More specifically, the system controller 26 prevents the video signal from being transmitted to the combination circuit 18, and feeds the OSD control signal of the help screen on the present item to the OSD display circuit 28. The help screen is a predetermined screen that is prepared as a screen that gives a description of the operation or the function on the television receiver 1.

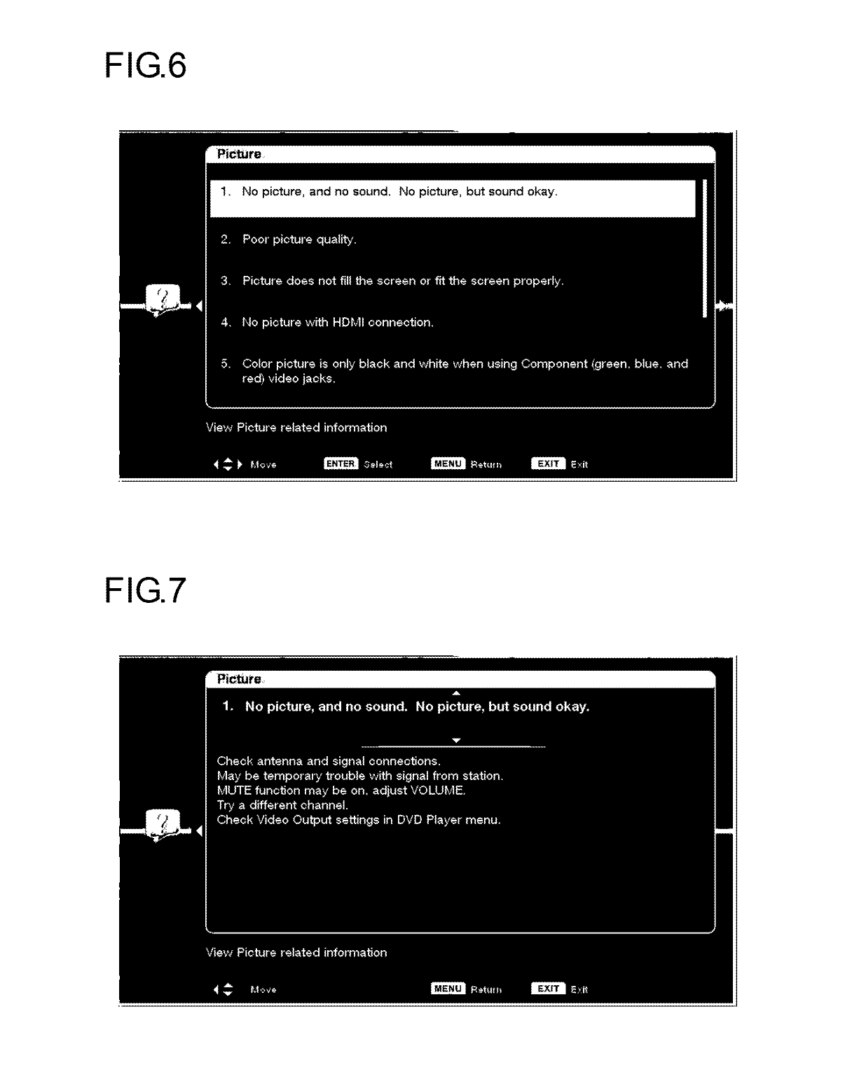

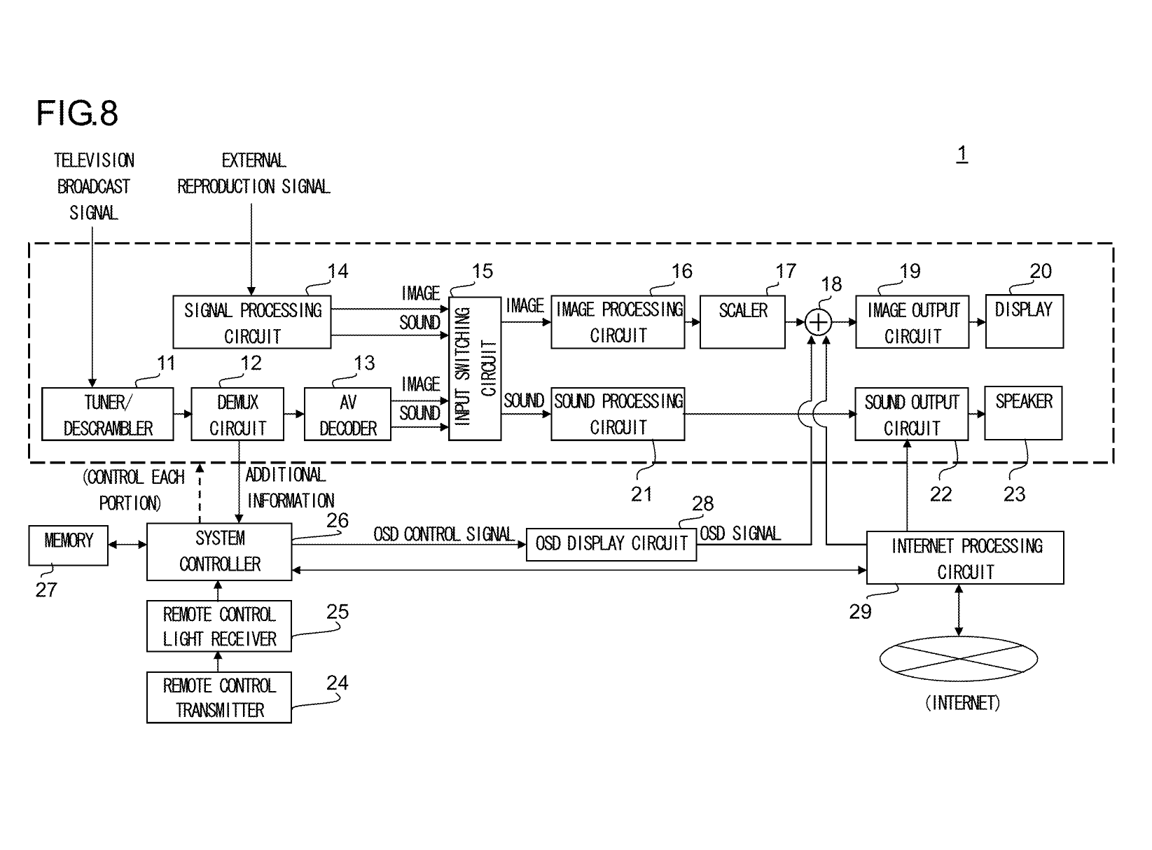

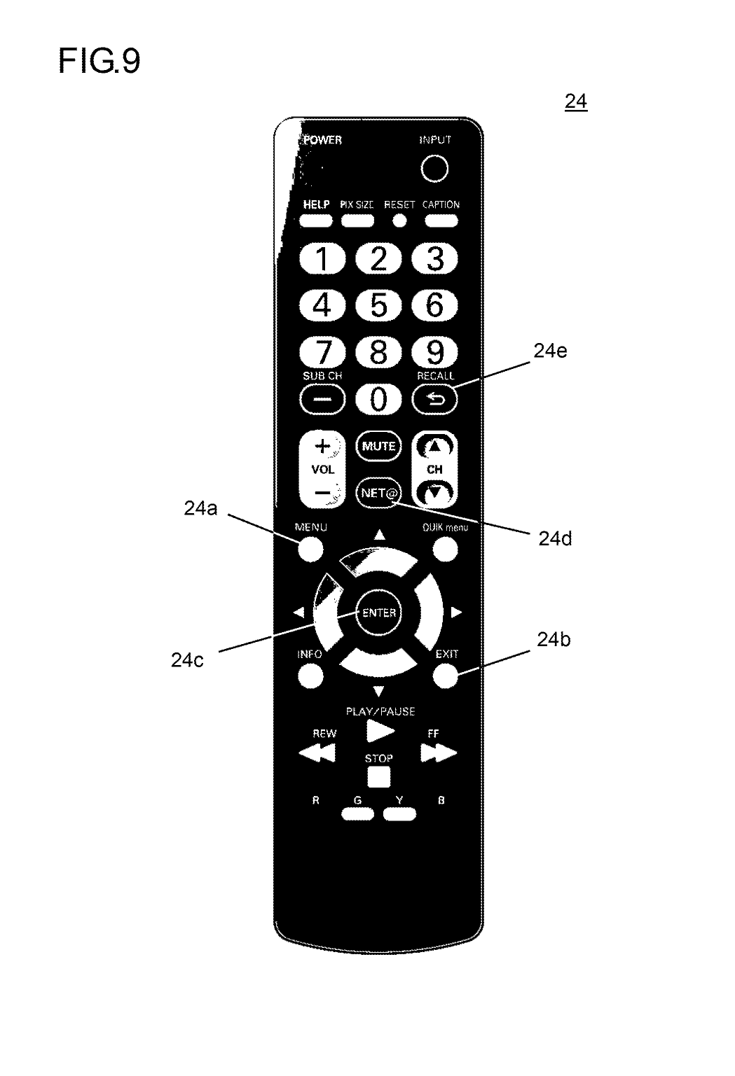

Consequently, as shown in FIGS. 6 and 7, the display form of the display 20 is turned into a form (hereinafter referred to as a “third display form” for convenience) in which the image is not displayed and the help screen is displayed. FIG. 6 shows, as an example, a display form in which an operation is performed to select the help screen item “Picture” and the help screen on the picture (image) is displayed.

In the help screen, on an individual help screen item basis, a question screen (see FIG. 6) representing the items of various questions on the side of the user and an answer screen (see FIG. 7) representing answers for the questions are prepared. When the help screen is displayed, the question screen is first displayed, and then, when the use performs an operation to select any one of the items, the answer screen corresponding to the selected item is displayed.

In order to increase, as much as possible, the number of characters that can be displayed on the same screen, the help screen is set such that the help screen is displayed to cover the most of the display region of the display 20; even when a long descriptive sentence is displayed, the increase in the number of pages is reduced as much as possible. Thus, an attempt to enhance the operability when the help screen is displayed is performed, and the user can check the descriptive sentence by performing a small amount of operation on the keys.

Since, in the third display form, the image is not displayed, even if the help screen is displayed to cover the most of the display region of the display 20, it is prevented that the help screen interferes with the image and that thus the descriptive sentence is difficult to check.

[Others]

As has been described above, the television receiver 1 of the present embodiment selectively receives any one of a plurality of content signals including signals of television broadcast, and displays the image (display content) of the received content signal on the display 20. The television receiver 1 includes: a function portion (a switching portion) that switches the received content signal according to a predetermined switching operation and thereby switches the display content displayed on the display 20; a function portion (a menu screen display portion) that displays, on the display 20, the menu screen 51 representing a list of operation items; and a function portion (a display control portion) that controls the display form of the display 20.

When the image of the content signal and the menu screen 51 are displayed on the display 20 side by side, the display control portion reduces the image and turns the display form into the first display form in which the reduced image is displayed at a predetermined position on the small screen. When the switching operation is performed with the display form being the first display form, the display control portion switches the display content while the first display form is being maintained as the present display form.

Hence, the television receiver 1 displays an image of a television program or the like on the small screen while the menu screen 51 is being displayed, and the television program or the like displayed on the small screen can be switched by the user.

The menu screen 51 represents a list of the image quality adjustment items on the image displayed on the display 20, a list of the help screen items corresponding to a plurality of help screens (illustrative screens) previously prepared and the like.

When an operation is performed to select any one of the image quality adjustment items with the menu screen 51 displayed, the television receiver 1 is on standby for the image quality adjustment operation corresponding to the selected item. Then, when the television receiver 1 is on standby for the image quality adjustment operation with the display form being the first display form, the display control portion prevents the image from being reduced, and changes the display form into the second display form in which the image is displayed to cover the overall screen.

Furthermore, when an operation is performed to select any one of the help screen items with the menu screen 51 displayed, the television receiver 1 displays the help screen corresponding to the selected item. Then, when the help screen is displayed with the display form being the first display form, the display control portion changes the display form into the third display form in which the image is not displayed and the help screen is displayed.

Instead of (or in addition to) the menu screen display portion, the television receiver 1 may include a function portion (a net content display portion) that displays, on the display 20, content (net content) provided through the Internet. Specifically, the net content display portion has the function of connecting to the Internet, the function of receiving the provision of net content from a server through the Internet and the function of displaying the net content on the display 20. In this case, the function portion (the display control portion) for controlling the display form of the display 20 can display the net content according to the menu screen 51 in the first display form.

When the image (an image of a television program or the like) of the content signal and the net content are displayed on the display 20 side by side, the display control portion reduces the image and turns the display form of the display 20 into the fourth display form in which the reduced image is displayed at a predetermined position on the small screen. When the predetermined switching operation is performed with the display form of the display 20 being the fourth display form, the display control portion switches the display content with the fourth display form maintained as the display form.

In this way, the television receiver 1 displays an image of a television program or the like on the small screen while net content is being displayed, and the television program or the like displayed on the small screen can be switched by the user. An example of the television receiver having the function of displaying net content on a display as described above is taken as the second embodiment of the present invention, and it will be described below.

### 2. The Second Embodiment

The second embodiment will now be described. In the description of the second embodiment, focus is placed on the description of parts that are different from the first embodiment, and the description of the same parts as in the first embodiment may not be repeated.

FIG. 8 is a block diagram of a television receiver 2 that is a display device according to the present embodiment. The television receiver 2 includes the tuner/descrambler 11, the DEMUX circuit 12, the AV decoder 13, the signal processing circuit 14, the input switching circuit 15, the image processing circuit 16, the scaler 17, the combination circuit 18, the image output circuit 19, the display 20, the sound processing circuit 21, the sound output circuit 22, the speaker 23, the remote control transmitter 24, the remote control light receiver 25, the system controller 26, the memory 27, the OSD display circuit 28 and an Internet processing circuit 29.

As described above, in addition to the constituent components included in the television receiver 1 (see FIG. 1) of the first embodiment, the television receiver 2 includes the Internet processing circuit 29. The Internet processing circuit 29 is connected to the Internet, and performs various types of processing on Internet communication according to an instruction from the system controller 26 or the like.

In addition to processing necessary to perform the Internet communication, the Internet processing circuit 29 can perform processing for feeding image data on acquired net content to the combination circuit 18 and displaying it on the display 20, processing for feeding sound data on the acquired net content to the sound output circuit 22 and outputting it from the speaker 23 and the like.

FIG. 9 is a diagram showing the appearance of the remote control transmitter 24 according to the present embodiment. As shown in this figure, keys (operation switches) incorporated in the remote control transmitter 24 include a “MENU” key 24a, an “EXIT” key 24b, an “ENTER” key 24c, a “NET@” key 24d and a “RECALL” key 24e.

The television receiver 2 can perform the same operations as the television receiver 1 according to the first embodiment. Specifically, the television receiver 2 performs the operations in the normal mode and the operations in the menu mode that have already been described. Likewise, in the television receiver 2, in the menu mode, the image 52 is displayed on the small screen, and furthermore, the image 52 on the small screen is switched according to a switching operation or the like of the reception channel by the remote control transmitter 24.

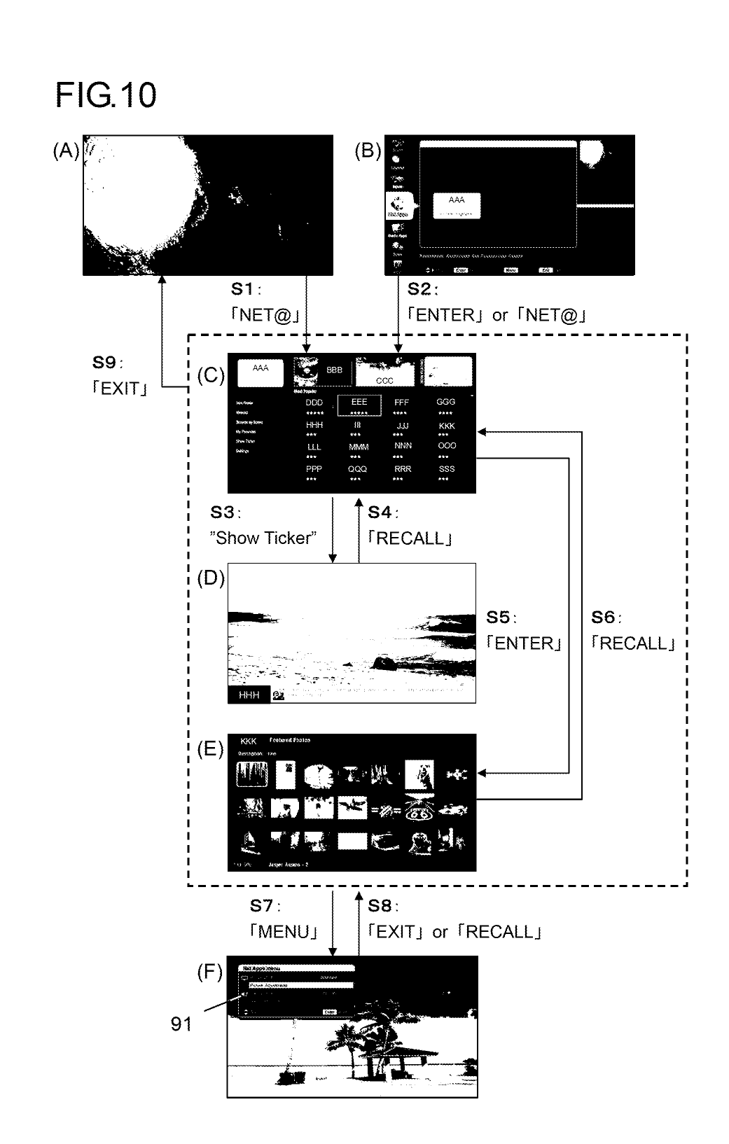

In addition to the operations described above, the television receiver 2 performs operations in a net mode. In the net mode, the Internet communication is performed, and, for example, various Internet applications (hereinafter referred to as applications, for short) can be utilized. Transfer to the net mode, operations in the net mode and the like will now be described below with reference to FIG. 10. In FIGS. 10 to 12, “AAA” represents the name of a company that provides a net portal screen or the name of a service, “BBB” and “CCC” represent the characters of an advertisement and “DDD” to “SSS” represent the names of companies that provide net content or the names of services.

FIG. 10 is a diagram illustrating and schematically showing the transfer to the net mode and the operations in the net mode. FIGS. 10(A) to 10(F) show display forms of the display 20. Specifically, (A) a display form in the normal mode, (B) a display form in the menu mode, (C) a display mode in which a net portal screen is displayed, (D) a display mode in a ticker mode, (E) a display mode in which a certain application is being performed and (F) a display mode in which a mini menu screen 91 is displayed are shown. Steps S1 to S9 shown in FIG. 10 indicate operation instructions (mainly, key operations on the remote control transmitter 24) by the user.

When an instruction to transfer to the net mode is provided, the system controller 26 transfers the television receiver 2 to the net mode. More specifically, when, in the normal mode, the “NET@” key 24d is operated (step S1), transfer to the net mode is performed. Moreover, when, in the menu mode, the “NET@” key 24d is operated or the “ENTER” key 24c is operated with an item of an instruction to transfer to the net mode being selected (step S2), transfer to the net mode is performed.

When the transfer to the net mode is performed, the Internet processing circuit 29 accesses a preregistered specific server (hereinafter referred to as a “main server” for convenience) on the Internet. The main server is organized by a provider of the net portal screen or the like, and provides the television receiver 2 with various types of net content.

The main server transmits, according to the access from the Internet processing circuit 29, data (one type of net content) on the net portal screen to the Internet processing circuit 29. Thereafter, the system controller 26 displays the net portal screen and the image 52 on the small screen (the image of the content signal) on the display 20 side by side. Thus, the display form of the display 20 is turned into a form as shown in FIG. 10(C). The system controller 26 outputs, from the speaker 23, sound (the sound of the content signal) corresponding to the image 52 on the small screen.

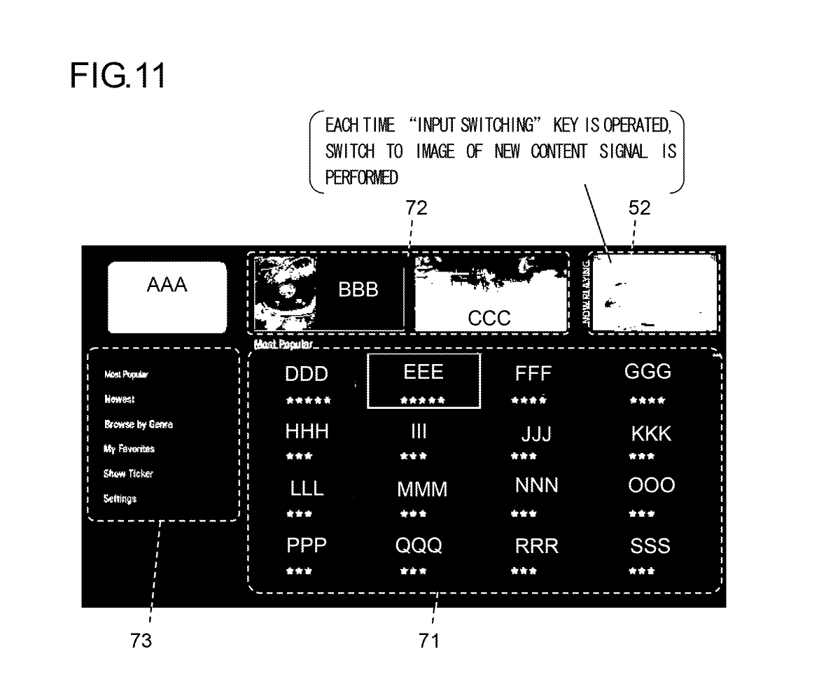

FIG. 11 is an enlarge view of the display form (the state where the net portal screen is displayed) shown in FIG. 10(C). As shown in FIG. 11, on the display 20, the image 52 on the small screen is displayed in an upper right portion, and the net portal screen is displayed in a region that does not cover the image 52 on the small screen.

As the image 52 on the small screen is displayed in the menu mode, when a content signal to be received is switched, the image 52 on the small screen is switched to an image of a content signal that is received after the switching. Thus, the user switches a content signal to be received by the key operation or the like of the remote control transmitter 24, and thereby can watch the desired image of the content signal with the net portal screen displayed.

As shown in FIG. 11, on the net portal screen, an application list region 71, an advertisement region 72, a view mode list region 73 and the like are provided. The net portal screen mainly makes it easy for the user to select a desired application, and also functions to receive the selection and specification of an application.

The application list region 71 is a region on which a list of various applications (the logos thereof) that can be fed to the television receiver 2 is displayed. On the application list region 71, a cursor that is moved according to the key operation of the remote control transmitter 24 is displayed. Thus, the user can easily select and specify an arbitrary application in the list. The advertisement region 72 is a region on which various advertisement images prepared by the side of an organizer of the main server are displayed.

The view mode list region 73 is a region on which a list of items on a view mode is displayed. As the items on the view mode, “Most Popular”, “Newest”, “Browse by Genre”, “My Favorites”, “Show Ticker” and “Settings” are provided. On the view mode list region 73, the cursor that is moved according to the key operation of the remote control transmitter 24 is also displayed. Thus, the user can easily select and specify an arbitrary item in the list.

The item “Most Popular” is an item for limiting the applications in the list displayed on the application list region 71 to popular applications. When this item is selected and specified, only applications selected as high-ranked ones from all the applications based on “popular” are included in the list on the application list region 71.

Thus, the applications in the list can be narrowed to relatively popular ones, and this makes it easy for the user to select a desired application. The narrowing of the applications based on “popular” described above is previously performed by the organizer of the main server.

The item “Newest” is an item for limiting the applications in the list displayed on the application list region 71 to new applications. When this item is selected and specified, only applications selected as high-ranked ones from all the applications based on “new” are included in the list on the application list region 71.

Thus, the applications in the list can be narrowed to relatively new ones, and this makes it easy for the user to select a desired application. The narrowing of the applications based on “new” described above is previously performed by the organizer of the main server.

The item “Browse by Genre” is an item for limiting the applications in the list displayed on the application list region 71 to applications of a genre specified by the user. When this item is selected and specified, only applications of the genre specified by the user among all the applications are included in the list on the application list region 71.

Thus, the applications in the list can be narrowed to ones of the desired genre, and this makes it easy for the user to select a desired application. To what genre each application belongs is previously determined by the organizer of the main server.

The item “My Favorites” is an item for limiting the applications in the list displayed on the application list region 71 to one or a plurality of favorite applications (previously specified by the user). When this item is selected and specified, only favorite applications are included in the list on the application list region 71.

Thus, the applications in the list can be narrowed to user's favorite ones, and this makes it easy for the user to select a desired application.

The item “Show Ticker” is an item for transfer to the ticker mode. When this item is selected and specified, the display form of the display 20 is transferred from a form in which the net portal screen is displayed to a display form in the ticker mode.

The item “Settings” is an item for browsing and setting predetermined information (such as various types of version information) on communication with the main server and the like. When this item is selected and specified, a screen representing the details of the predetermined information is displayed, and thus it is possible to browse and set the information.

With reference back to FIG. 10, when, in a state where the net portal screen is displayed, the item “Show Ticker” on the view mode list region 73 is selected and specified (step S3), the main server accordingly transmits data (one type of net content) on the ticker mode screen to the Internet processing circuit 29.

Thereafter, the system controller 26 displays the ticker mode screen and the image of the received content signal on the display 20 side by side. Thus, as shown in FIG. 10(D), the display mode of the display 20 is turned into the display mode in the ticker mode. Here, the system controller 26 outputs the sound of the content signal from the speaker 23.

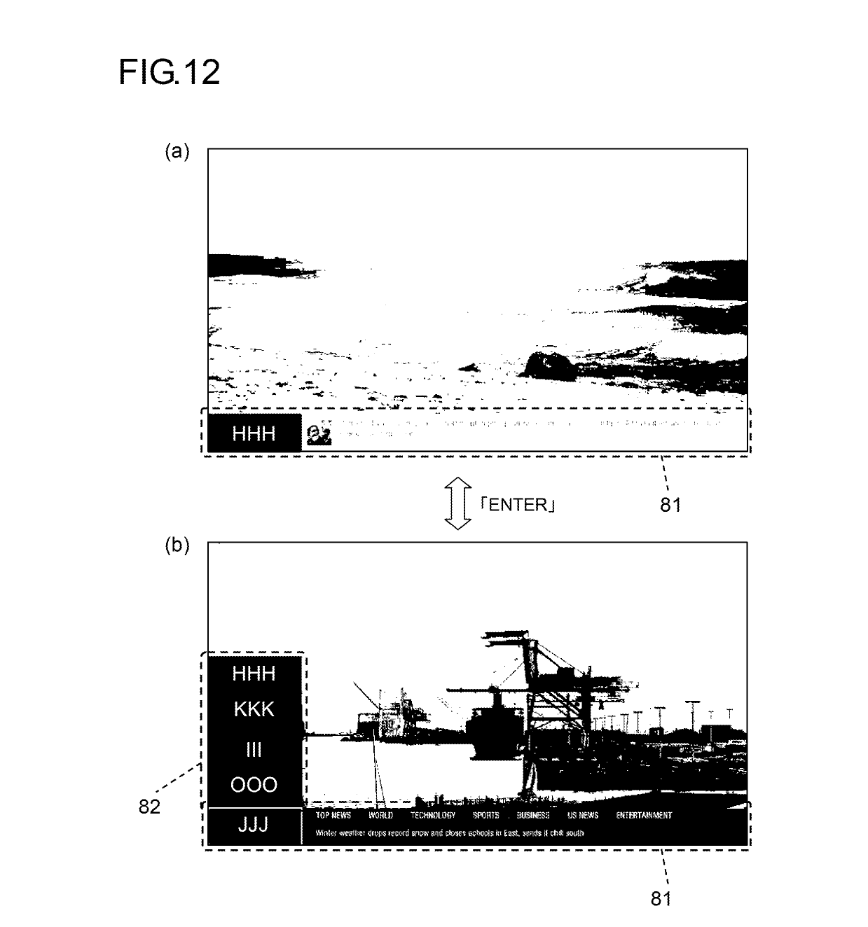

FIG. 12 is a diagram illustrating in more detail the display form in the ticker mode. As shown in FIG. 12, on the display 20, the image of the received content signal is displayed such that the size thereof is increased, and the ticker mode screen is displayed in a limited lower part.

Each time the “ENTER” key 24c is operated, the display form in the ticker mode is switched between the display mode shown in FIG. 12(a) and the display mode shown in FIG. 12(b). On the ticker mode screen shown in FIG. 12(a), an active ticker display region 81 is provided; in addition to this, on the ticker mode screen shown in FIG. 12(b), a non-active ticker display region 82 is provided.

On the active ticker display region 81, the logo of a ticker option that is set active is displayed, and the content (mainly, a character string) of the ticker option is displayed by a ticker display method (a method of display with flow in a predetermined direction). On the non-active ticker display region 82, the logo of each ticker option that is set non-active is displayed.

In the display form shown in FIG. 12(b), a cursor (that is moved according to the key operation of the remote control transmitter 24) for selecting the logo of any ticker option is displayed. The ticker option of the selected and specified logo is newly set active. Thus, the user can freely switch the active ticker option.

With reference back to FIG. 10, when the “RECALL” key 24e is operated with the display 20 in the display form of the ticker mode (step S4), the ticker mode is completed, and the state is returned to a state where the net portal screen is displayed.

When any one of the applications on the application list region 71 is selected and specified, that is, when the “ENTER” key 24c is operated with the cursor placed on the present application (step S5), the main server transmits data (one type of net content) on the present application to the Internet processing circuit 29.

When the data on the selected and specified application is stored in another server, the main server instructs this server to transmit the data to the Internet processing circuit 29. Thereafter, as illustrated in FIG. 10(E), the system controller 26 performs the present application. For example, based on the present application, the television receiver 2 performs image display and sound output. Here, the display of the image 52 on the small screen is completed, and the image of the application is displayed on the display 20 to cover the overall screen.

When the “RECALL” key 24e is operated with the application performed (step S6), the performance of the application is completed, and the state is returned to the state where the net portal screen is displayed.

When the “MENU” key 24a is operated with the display 20 in any one of the display forms of FIGS. 10(C) to 10(E) (step S7), as illustrated in FIG. 10(F), the mini menu screen 91 is displayed. The mini menu screen 91 is a screen for receiving adjustments on the image quality, the sound quality and the like in the television receiver 2, and is displayed on a region of the display 20. The mini menu screen 91 is displayed as appropriate, and thus the user can easily adjust the image quality, the sound quality and the like.

When the “EXIT” key 24b or the“RECALL” key 24e is operated with the mini menu screen displayed (step S8), the display of the mini menu screen 91 is completed. In other words, the display form of the display 20 is returned to the state immediately before the mini menu screen 91 is displayed.

When the “EXIT” key 24b is operated with the display 20 in any one of the display forms of FIGS. 10(C) to 10(E) (step S9), the net mode is completed, and the television receiver 2 is returned to the normal mode.

As has been described above, the television receiver 2 includes: the display 20; a function portion (a reception portion) that receives the content signal; and a function portion (an acquisition portion) that acquires the net content provided through the Internet. The television receiver 2 further includes a function portion (a display portion) that displays, on the display 20 side by side, the net content (for example, the net portal screen) and the image of the content signal displayed on the small screen. When the content signal to be received is switched while the side-by-side display described above is being performed, the image displayed on the small screen is switched to an image of a content signal that is received after the switching.

Although the embodiments of the present invention have been described above, the present invention is not limited to what has been described above. In the embodiments of the present invention, many modifications are possible without departing from the spirit of the present invention. According to the display device of the present invention, the image of a television program or the like is displayed on the small screen while the menu screen or the like is being displayed, and the television program or the like displayed on the small screen can be switched by the user. The “content” described in the present invention is not limited to the content of a television program; it is a concept that includes content reproduced by an external reproduction device. The “net content” means content provided from a server through the Internet.

What is claimed is:

1. A display device that selectively receives any one of a plurality of content signals and that displays an image of the received content signal on a display, the display device comprising:
a switching portion that switches the content signal to be received according to a predetermined switching operation such that display content displayed on the display is switched;
a menu screen display portion that displays, on the display, a menu screen representing a list of operation items; and
a display control portion that controls a display form of the display,
wherein, when the image and the menu screen are displayed on the display side by side, the display control portion reduces the image, and turns the display form into a first display form in which the reduced image is displayed at a predetermined position on a small screen, and
when the switching operation is performed with the display form being the first display form, the display control portion switches the display content while the first display form is being maintained as the display form.

2. The display device of claim 1,
wherein the menu screen represents a list of image quality adjustment items on the image displayed on the display,
when an operation is performed to select any one of the image quality adjustment items with the menu screen displayed, the display device is placed on standby for an image quality adjustment operation corresponding to the selected item and
when the display device is placed on standby for the image quality adjustment operation with the display form being the first display form, the display control portion prevents the image from being reduced, and turns the display form into a second display form in which the image is displayed to cover the overall screen.

3. The display device of claim 2,
wherein, when the display device is placed on standby for the image quality adjustment operation, an image quality adjustment screen for assisting the image quality adjustment operation is displayed, and
the second display form is a display form in which the image quality adjustment screen is displayed to overlap the image displayed to cover the overall screen.

4. The display device of claim 3,
wherein, when the switching operation is performed with the display form being the second display form, the display control portion switches the display content while the second display form is being maintained as the display form, and
an image quality adjustment corresponding to the image quality adjustment operation is reflected on the image displayed on the display.

5. The display device of claim 1,
wherein the menu screen represents a list of predetermined screen items corresponding to a plurality of predetermined screens previously prepared,
when an operation is performed to select any one of the predetermined screen items with the menu screen displayed, a predetermined screen corresponding to the selected item is displayed and
when the predetermined screen is displayed with the display form being the first display form, the display control portion turns the display form into a third display form in which the image is not displayed and the predetermined screen is displayed.

6. The display device of claim 5,
wherein each of the predetermined screens is an illustrative screen that illustrates an operation or a function on the display device.

7. A display device that selectively receives any one of a plurality of content signals and that displays an image of the received content signal on a display, the display device comprising:
a switching portion that switches the content signal to be received according to a predetermined switching operation such that content displayed on the display is switched;
a net content display portion that displays, on the display, net content provided through the Internet; and
a display control portion that controls a display form,
wherein, when the image and the net content are displayed on the display side by side, the display control portion reduces the image, and turns the display form into a fourth display form in which the reduced image is displayed at a predetermined position on a small screen, and
when the switching operation is performed with the display form being the fourth display form, the display control portion switches the content while the fourth display form is being maintained as the display form.

8. A display device comprising:
a display;
a reception portion that receives a content signal;
an acquisition portion that acquires net content provided through the Internet; and
a display portion that displays, on the display side by side, the net content and an image of the content signal displayed on a small screen,
wherein, when the content signal to be received is switched with the side-by-side display produced, the image displayed on the small screen is switched to an image of a content signal that is received after the switching.
